(19) United States
(12) Patent Application Publication
(10) Pub. No.: US 2025/0201025 A1
(43) Pub. Date: Jun. 19, 2025

(54) INFORMATION PROCESSING APPARATUS, INFORMATION PROCESSING METHOD, AND PROGRAM

(71) Applicant: SONY GROUP CORPORATION, TOKYO (JP)

(72) Inventor: YUGO SATO, TOKYO (JP)

(21) Appl. No.: 18/849,721

(22) PCT Filed: Mar. 20, 2023
(86) PCT No.: PCT/JP2023/010942

§ 371 Date: Sep. 23, 2024

(30) Foreign Application Priority Data
Apr. 1, 2022 (JP) 2022-061693

(51) Int. Cl. G06V 40/20; G06V 20/20; G06V 40/10

(52) U.S. Cl. CPC G06V 40/28; G06V 40/11; G06V 20/20

(57) ABSTRACT

The present technology relates to an information processing apparatus, an information processing method, and a program that enable stable estimation (recognition) of a hand pose.

A hand pose in a human body is estimated on the basis of an image of the human body, and the hand pose is estimated using auxiliary information that limits a degree of freedom of the hand pose.

### TECHNICAL FIELD

The present technology relates to an information processing apparatus, an information processing method, and a program, and particularly, to an information processing apparatus, an information processing method, and a program that can stably estimate (recognize) a hand pose.

### BACKGROUND ART

PTL 1 discloses technology for extending a prediction range of a motion model of a part where concealment occurs from that of a motion model of a part where concealment does not occur, for prediction, on the basis of past pose estimation information and concealment information of each part.

### CITATION LIST

### Patent Literature

[PTL 1]
JP 2007-310707A

### SUMMARY

### Technical Problem

In augmented reality (AR), virtual reality (VR), or the like, various operations are performed by a hand pose of a user, and it is necessary to stably estimate (recognize) the hand pose.

The present technology has been developed in view of such a situation, and makes it possible to stably estimate (recognize) a hand pose.

### Solution to Problem

An information processing apparatus or a program of the present technology is an information processing apparatus including a hand pose estimation processing unit configured to estimate a hand pose in a human body on the basis of an image of the human body, the hand pose estimation processing unit estimating the hand pose using auxiliary information that limits a degree of freedom of the hand pose, or a program for causing a computer to function as such an information processing apparatus.

An information processing method of the present technology is an information processing method, including: estimating, by a hand pose estimation processing unit of an information processing apparatus including the hand pose estimation processing unit, a hand pose in a human body on the basis of an image of the human body, and estimating the hand pose using auxiliary information that limits a degree of freedom of the hand pose.

In the information processing apparatus, the information processing method, and the program of the present technology, a hand pose in a human body is estimated on the basis of an image of the human body, and the hand pose is estimated using auxiliary information that limits a degree of freedom of the hand pose.

### BRIEF DESCRIPTION OF DRAWINGS

FIG. 1 is a block diagram illustrating an example of a hardware configuration of an information processing apparatus according to the present embodiment.

FIG. 2 is a functional block diagram illustrating a functional configuration of the information processing apparatus.

FIG. 3 is a diagram illustrating a flow of a series of processing of the information processing apparatus.

FIG. 4 is a block diagram illustrating a specific configuration example of an image recognition processing unit of the information processing apparatus.

FIG. 5 is a diagram illustrating an inference model that estimates a hand pose from an input image.

FIG. 6 is a diagram illustrating joint points estimated as hand poses.

FIG. 7 is a diagram illustrating input and output of a hand pose estimation unit.

FIG. 8 is a diagram illustrating a first usage example of a future pose.

FIG. 9 is a diagram illustrating a first usage example of the future pose.

FIG. 10 is a diagram illustrating a first usage example of the future pose.

FIG. 11 is a flowchart showing an example of a processing procedure of an input image processing unit and an image recognition processing unit in FIG. 2.

FIG. 12 is a diagram illustrating a first modification example in which a calculation load is controlled using auxiliary information.

FIG. 13 is a block diagram illustrating a specific configuration example of an image recognition processing unit of an information processing apparatus for realizing the first modification example.

FIG. 14 is a flowchart showing an example of a processing procedure of the input image processing unit of FIG. 2 and the image recognition processing unit of FIG. 13.

FIG. 15 is a diagram illustrating a second modification example in which a calculation load is controlled using auxiliary information.

FIG. 16 is a block diagram illustrating a specific configuration example of an image recognition processing unit of an information processing apparatus that realizes the second modification example.

FIG. 17 is a flowchart showing an example of a processing procedure of the input image processing unit of FIG. 2 and the image recognition processing unit of FIG. 16.

### DESCRIPTION OF EMBODIMENTS

Hereinafter, embodiments of the present technology will be described with reference to the drawings.

### Information Processing Apparatus According to Present Embodiment

Specifically, the information processing apparatus according to the embodiment to which the present technology is applied (the present embodiment) is a smartphone, a head mounted display (HMD), a face-to-face camera, and the like. However, the information processing apparatus to which the present technology is applied is not limited to a device that is used for a specific purpose.

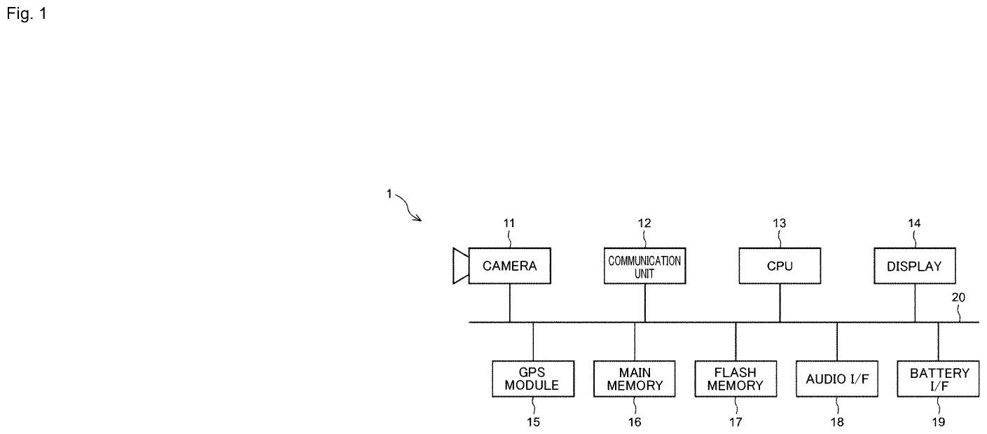

FIG. 1 is a block diagram illustrating an example of a hardware configuration of the information processing apparatus according to the present embodiment. The information processing apparatus 1 in FIG. 1 includes a camera 11, a communication unit 12, a central processing unit (CPU) 13, a display 14, a Global Positioning System (GPS) module 15, a main memory 16, a flash memory, 17, an audio I/F 18, and a battery I/F 19 which are interconnected by a bus 20. The respective units 11 to 19 exchange various pieces of data and control signals via the bus 20.

The camera 11 represents any type of camera or sensor (camera sensor) that detects (acquires) a subject (human body) as a two-dimensional image, and supplies the acquired image to the CPU 13 and the like. The image captured by the camera 11 may be an RGB image (color image) acquired by an RGB sensor, a grayscale image acquired by a monochrome sensor, or a distance image (depth image) acquired by Time of Flight (ToF), or may include such a plurality of types of images. When a distinguishment is made between a color image or a grayscale image in which a pixel value of each of pixels in a two-dimensional array is a value according to the brightness of an object point corresponding to each pixel and a depth image in which the pixel value of each of the pixels in the two-dimensional array is a value according to a distance (depth) to the object point corresponding to each pixel, the former is referred to as image information, and the latter is referred to as depth information. Further, the image acquired by the camera 11 may be a still image or may be a moving image. The communication unit 12 controls communication with external devices. The communication may be, for example, communication based on a standard such as wireless local area network (LAN), Bluetooth (registered trademark), or mobile communication, and is not limited to a specific standard.

The CPU 13 executes a series of processing to be described later by loading a program stored in the flash memory 17 into the main memory 16 and executing the program. The display 14 displays various types of information. The GPS module 15 detects a current location of its own device using artificial satellites. The main memory 16 is, for example, a random access memory (RAM), and temporarily stores data referred to by the CPU 13 or calculated data. The flash memory 17 is, for example, an EEPROM, and stores programs executed by the CPU 13, control parameters, and the like. An audio input device (microphone) such as a microphone or an audio output device such as a speaker is connected to the audio I/F 18, and an audio signal is input or output. The battery I/F 19 controls the charging of the battery installed in the information processing apparatus 1 or the supply of power from the battery to each unit.

The series of processing in the information processing apparatus 1 can be executed by hardware or can be executed by software. When a series of processing is executed by software, programs that make up the software are installed on the computer. Here, examples of the computer include a computer built into dedicated hardware and, for example, a general-purpose personal computer that can execute various functions by installing various programs.

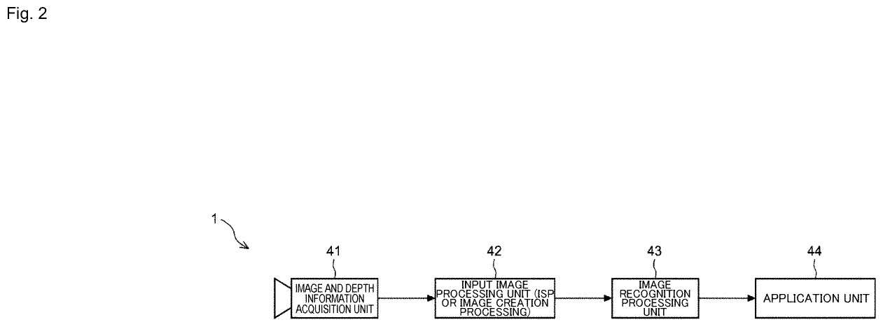

FIG. 2 is a functional block diagram illustrating a functional configuration of the information processing apparatus 1 of FIG. 1. In FIG. 2, the information processing apparatus 1 includes an image and depth information acquisition unit 41, an input image processing unit 42, an image recognition processing unit 43, and an application unit 44.

The image and depth information acquisition unit 41 acquires an image of a subject (at least one of image information and depth information) using the camera 11 in FIG. 1 at predetermined time intervals, and supplies the image to the input image processing unit 42. An image for one screen sequentially acquired at the predetermined time intervals is also referred to as a frame.

The input image processing unit 42 is a functional block realized by the CPU 13 in FIG. 1 executing a program, and performs image creation processing for image signal processing (ISP) such as demosaic processing, noise removal, and distortion correction or recognition processing in the image recognition processing unit 43 on the image from the image and depth information acquisition unit 41, and supplies a resultant image to the image recognition processing unit 43.

The image recognition processing unit 43 is a functional block realized by the CPU 13 in FIG. 1 executing the program, and estimates (recognizes) a pose of the human body (body pose: human body pose) and the pose of the finger (hand pose: hand pose) photographed by the camera 11 on the basis of the image from the input image processing unit 42. Information (pose information) on the estimated body pose and hand pose (body and hand pose) is supplied to the application unit 44.

The application unit 44 is a functional block realized by the CPU 13 in FIG. 1 executing a program, and executes processing according to an application including the program on the basis of the pose information from the image recognition processing unit 43. For example, the application unit 44 executes processing as a user interface (UI) that recognizes user operations on the basis of the pose information. The application including the program executed by the application unit 44 is not limited to a specific type.

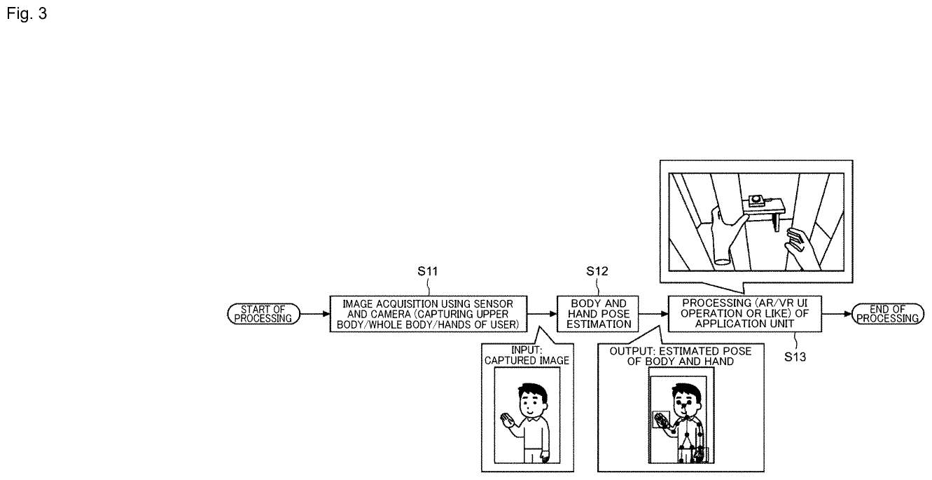

FIG. 3 is a diagram illustrating a series of processing flows of the information processing apparatus 1. In FIG. 3, in step S11, the image and depth information acquisition unit 41 acquires an image (at least one of image information and depth information) of a subject using the camera 11 of FIG. 1 at predetermined time intervals. In this case, the image and depth information acquisition unit 41 acquires (captures) an image of an upper body, whole body, or a hand of the user as the subject. Next, in step S12, the input image processing unit 42 and the image recognition processing unit 43 estimate the body and hand poses for each frame with respect to the image (captured image) acquired and inputted in step S11. Next, in step S13, the application unit 44 performs processing according to an application (program) executed by the application unit 44, on the basis of the body and hand pose estimated in step S12. For example, the application unit 44 performs, for example, processing of recognizing a UI operation that is performed using body and hand poses by the user in augmented reality (AR) or virtual reality (VR).

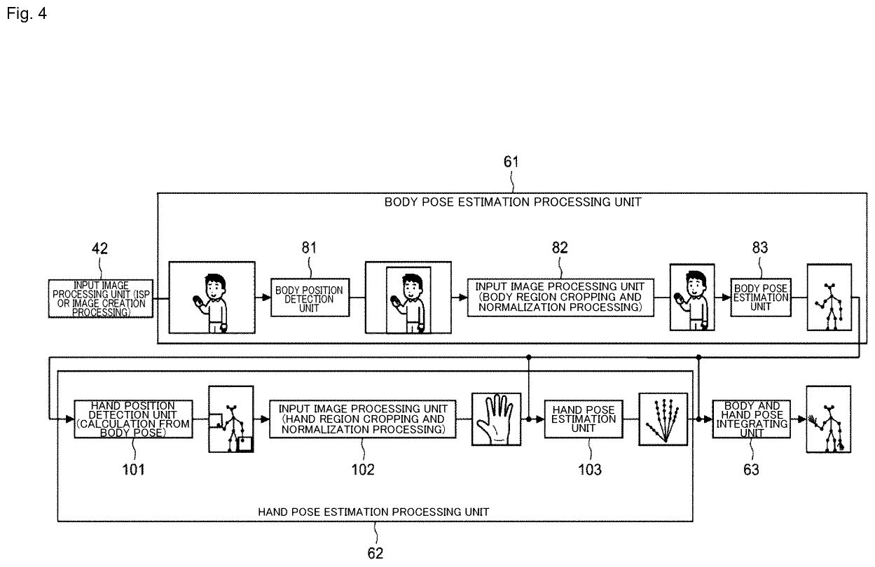

FIG. 4 is a block diagram illustrating a specific example of a configuration of the image recognition processing unit 43 of the information processing apparatus 1. In

FIG. 4, the image recognition processing unit 43 includes a body pose estimation processing unit 61, a hand pose estimation processing unit 62, and a body and hand pose integration unit 63.

The body pose estimation processing unit 61 takes in the image (target image) processed by the input image processing unit 42 also illustrated in FIG. 2, and estimates the body pose (human body pose) included in the target image for each frame. The body pose, which is an estimation result, is supplied to the hand pose estimation processing unit 62 and the body and hand pose integration unit 63.

The hand pose estimation processing unit 62 extracts an image of the hand region from the target image on the basis of the body pose from the body pose estimation processing unit 61, estimates the hand pose (a pose of the fingers) of the current frame, and predicts the hand pose in the next frame. When the hand pose estimation processing unit 62 estimates the hand pose, the hand pose estimation processing unit 62 uses a body pose and a hand pose estimated in a past frame as the auxiliary information. The hand pose of the current frame, which is the estimation result, is supplied to the body and hand pose integration unit 63.

The body and hand pose integration unit 63 generates a body and hand pose by integrating the body pose from the body pose estimation processing unit 61 and the hand pose from the hand pose estimation processing unit 62, and supplies the body and hand pose to the application unit 44 in FIG. 2

### (Body Pose Estimation Processing Unit 61)

The body pose estimation processing unit 61 includes a body position detection unit 81, an input image processing unit 82, and a body pose estimation unit 83. The body position detection unit 81 detects a position (image region) of a person for each frame in the target image from the input image processing unit 42. For example, an inference model having a structure of a deep neural network (DNN) generated by machine learning technology may be used to detect the position (image region) of the person. The inference model performs object detection on the input target image to detect the person (human body) in the target image, and outputs a range of a bounding box surrounding an image region of the person as information indicating the image region in which the person is captured. The position (image region) of the person (human body) is referred to as a body region. The body region detected for each frame by the body position detection unit 81 is supplied to the input image processing unit 82.

The input image processing unit 82 extracts (cuts out) the body region from the target image for each frame on the basis of the body region from the body position detection unit 81, and performs normalization processing on an image of the extracted body region (referred to as a body region image). The normalization processing is processing of converting the body region image to a predetermined image size (number of vertical and horizontal pixels) by performing pixel interpolation processing, pixel thinning processing, or the like on the body region image. The body region image extracted and normalized for each frame by the input image processing unit 82 is supplied to the body pose estimation unit 83.

The body pose estimation unit 83 estimates the body pose for each frame on the basis of the body region image from the input image processing unit 82. The estimation of the body pose is performed through estimation of the three-dimensional position (three-dimensional coordinates) of each joint point of the human body. Examples of the joint points estimated as the body pose include a position of each of shoulders, elbows, wrists, buttocks (hips), knees, ankles, eyes, and ears on the left and right sides of the human body, and a position of a neck at a center of the human body, and a nose. The body pose estimation unit 83 may use a pose estimation model having a DNN structure generated by a deep learning scheme such as Pose Proposal Network, Cascaded Pyramid Network (CPN), or GW-Pose in machine learning technology. The body pose estimation unit 83 supplies the body pose, which is an estimation result, to the hand pose estimation processing unit 62 and the body and hand pose integration unit 63.

### (Hand Pose Estimation Processing Unit 62)

The hand pose estimation processing unit 62 includes a hand position detection unit 101, an input image processing unit 102, and a hand pose estimation unit 103. The hand position detection unit 101 detects the hand position (image region) for each frame with respect to the body region image extracted by the input image processing unit 82 or the target image from the input image processing unit 42 on the basis of the body pose from the body pose estimation unit 83. The position of the hand (image region) in the target image is referred to as the hand region. The hand region detected for each frame is supplied to the input image processing unit 102.

The input image processing unit 102 extracts (cuts out) the hand region from the target image for each frame on the basis of the hand region from the hand position detection unit 101, and performs normalization processing on an image of the extracted hand region (referred to as a hand region image). The hand region image may be cut out from the body region image before or after normalization after being extracted by the input image processing unit 82 of the body pose estimation processing unit 61. The normalization processing of the input image processing unit 102 is a process of converting the hand region image to a predetermined image size (the number of vertical and horizontal pixels) by performing pixel interpolation processing, pixel thinning processing, or the like on the hand region image. The hand region image extracted and normalized for each frame by the input image processing unit 102 is supplied to the hand pose estimation unit 103.

The hand pose estimation unit 103 estimates the hand pose in the current frame on the basis of the hand region image from the input image processing unit 102, body poses for K past frames from the body pose estimation unit 83, and the hand poses for the K frames output in the past from the hand pose estimation unit 103, and predicts the hand pose one frame later (after one frame) as the future pose.

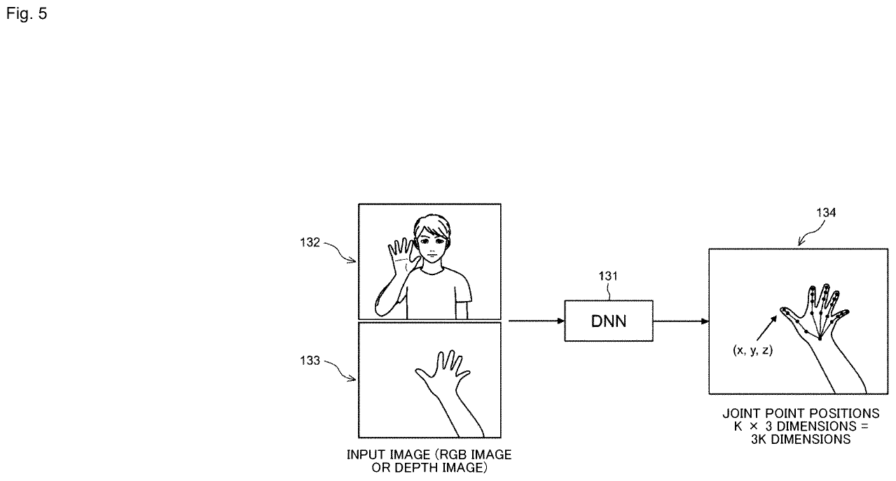

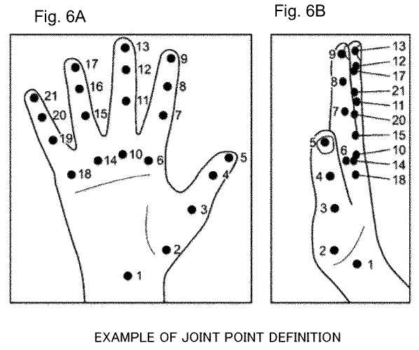

Here, FIG. 5 shows an inference model 131 having a DNN structure for estimating a hand pose from an input image. In FIG. 5, at least one of an RGB image (color image) 132 and a depth image 133 in which a hand is captured is input to the inference model 131 as the input image. The inference model 131 is an inference model having a structure of a DNN generated by machine learning technology, and is an inference model generated by a well-known scheme. The inference model 131 estimates the hand pose on the basis of the input image. The estimation of the hand pose is performed through estimation of a three-dimensional position (three-dimensional coordinates) of each joint (joint point) of the hand. The three-dimensional positions of the joint points estimated as the hand pose are, for example, positions numbered 1 to 21 (some are omitted in B) as shown in A and B in FIG. 6, for each of left and right hands. Number 1 represents a position of a wrist, and numbers 2 to 5 represent positions of a carpometacarpal joint (CM joint), metacarpophalangeal joint (MP joint), interphalangeal joint (IP joint), and fingertip, respectively. Positions numbered 6 to 9 represent positions of an MP joint, proximal phalangeal joint point (PIP joint), distal phalangeal joint point (DIP joint), and fingertip regarding an index finger, respectively. Positions numbered 10 to 13 represent positions of an MP joint, PIP joint, DIP joint, and fingertip regarding a middle finger, respectively. Positions numbered 14 to 17 represent positions of an MP joint, PIP joint, DIP joint, and fingertip regarding a ring finger, respectively. Positions numbered 18 to 21 represent positions of an MP joint, PIP joint, DIP joint, and fingertip regarding a little finger, respectively.

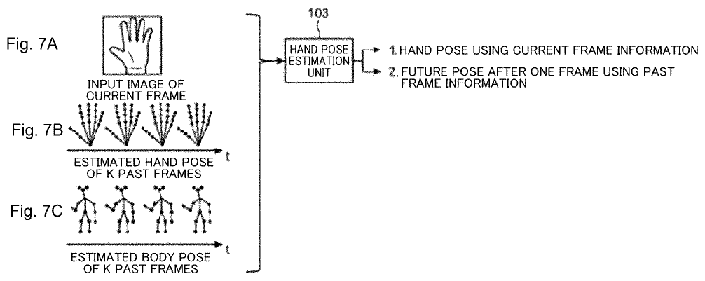

The hand pose estimation unit 103 is an inference model having the structure of a DNN generated by machine learning technology, and includes an inference model generated by the same scheme as the inference model 131. As illustrated in FIG. 7, the hand region image of the current frame is input to the hand pose estimation unit 103 from the input image processing unit 102 as an input image corresponding to the input image to the inference model 131 (see A of FIG. 7). Further, the body pose and the hand pose estimated for each frame from a frame K frames before the current frame to a frame one frame before the current frame are input to the hand pose estimation unit 103 as the auxiliary information (See B and C in the same figure). That is, the body pose and hand pose estimated from the K past frames (K past frames), which are time series information, are input to the hand pose estimation unit 103 as auxiliary information. A body pose estimated in the K past frames is the body pose estimated by the body pose estimation unit 83 for each of the K past frames, and the hand pose estimated in the K past frames is the hand pose estimated by the hand pose estimation unit 103 for each of the K past frames. The body pose and the hand pose estimated in the K past frames are not limited to being input to the hand pose estimation unit 103 at once when the hand region image (input image) of the current frame is input to the hand pose estimation unit 103. For example, the hand pose estimation unit 103 internally holds the hand pose in the current frame which is the estimation result, and when the hand region image (input image) of the current frame is input to the hand pose estimation unit 103, the body pose estimated in the immediately previous frame is input to the hand pose estimation unit 103, and the hand pose estimation unit 103 may internally store the body pose and the hand pose estimated in at least K past frames. Further, when the hand region image (input image) of the current frame is input to the hand pose estimation unit 103, the body pose and the hand pose estimated in the immediately previous frame may be input to the hand pose estimation unit 103, and the hand pose estimation unit 103 may internally store the body pose and the hand pose estimated in at least the k past frames. In these cases, the hand pose estimation unit 103 uses the body pose and hand pose of the K past frames accumulated internally when estimating the hand pose for the current frame and predicting the body pose and hand pose one frame later. Further, the body pose estimated in the K past frames may include the body pose estimated in the current frame.

The hand pose estimation unit 103 estimates the hand pose in the current frame on the basis of the hand region image of the current frame from the input image processing unit 102. In this case, the body pose and hand pose of the K past frames are used as auxiliary information, and in particular, the feature of the body pose is reflected in the estimation of the hand pose in the current frame. There may be a case where only one of the body pose and the hand pose of the K past frames is used as the auxiliary information. Further, the hand pose estimation unit 103 predicts the hand pose after one frame as the future pose after one frame from an estimation result of the hand pose in the current frame and the body pose and the hand pose estimated in the K past frames. Furthermore, estimation of the hand pose in the current frame and prediction of the future pose are performed by a single recognizer (inference machine), making it unnecessary to prepare a plurality of recognizers or perform control for switching between these recognizers.

The hand pose estimation unit 103 corrects the hand pose in the current frame, which is an estimation result, through time smoothing processing or the like, and then supplies a result of the correction to the body and hand pose integration unit 63. In the temporal smoothing processing, for example, correction is performed so that the position of each joint point estimated as information on the hand pose changes continuously over time with respect to the position in the past frame. The correction such as the time smoothing processing for the hand pose estimated in the current frame may not be performed or may be performed by a processing unit other than the hand pose estimation unit 103.

Further, the hand pose estimation unit 103 uses the future pose one frame later (hand pose) predicted one frame before as the hand pose in the current frame for estimation of the hand pose in the current frame when the hand pose is appropriately not estimated from the hand region image of the current frame, such as when an appropriate image is not obtained as the hand region image of the current frame from the input image processing unit 102.

### (First Usage Example of Future Pose)

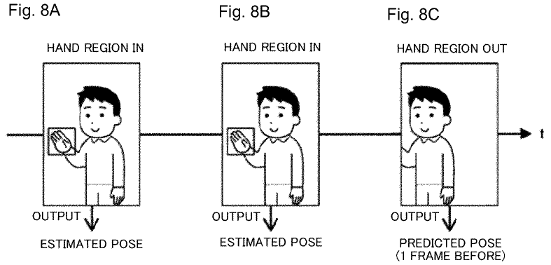

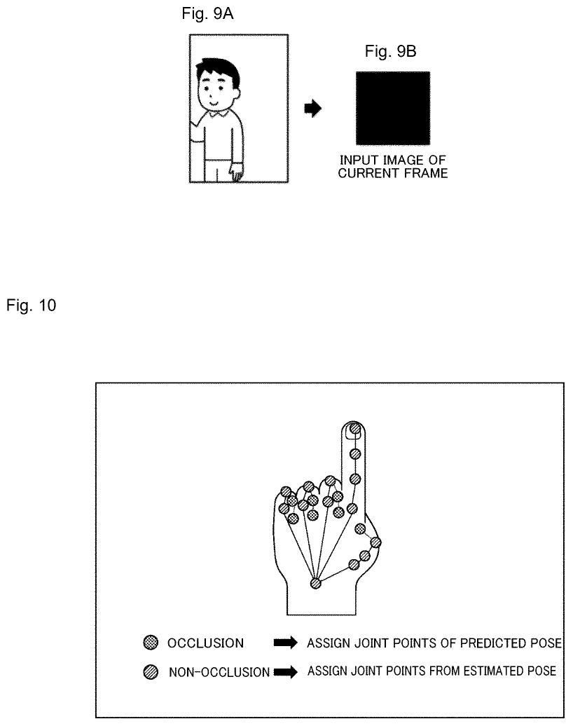

A first usage example in which the future pose is used for estimation of the hand pose in the current frame will be described and, in frames A and B in FIG. 8, it is assumed that both hand images are included in the body region image (or target image) output from the input image processing unit 82 of the body pose estimation processing unit 61. It is assumed that only one hand (right hand) is a target of hand pose estimation. In this case, for the hand region image of the current frame from the input image processing unit 102 to the hand pose estimation unit 103 in the hand pose estimation processing unit 62, a hand region image that includes an image of the hand (right hand) that is the estimation target is supplied. Therefore, the hand pose estimation unit 103 estimates and outputs the hand pose in the current frame on the basis of the hand region image of the current frame. On the other hand, it is assumed that, in a frame C of FIG. 8, the hand (right hand) that is the estimation target is not included in the body region image (or target image) output from the input image processing unit 82 of the body pose estimation processing unit 61. In this case, the input image processing unit 102 in the hand pose estimation processing unit 62 cannot supply the hand region image including the image of the hand (right hand) that is the estimation target as the hand region image of the current frame to the hand pose estimation unit 103. In this case, the input image processing unit 102 supplies the hand region image in which all pixel values are, for example, 0 (black), to the hand pose estimation unit 103 as shown in B of FIG. 9, as the hand region image in the current frame, for the body region image (or target image) in which the image of the hand of the estimation target is not included as shown in A of FIG. 9. The input image processing unit 102 is not limited to supplying the hand region image in which all the pixel values are 0,but may supply a hand region image in which all the pixel values are constant values to the hand pose estimation unit 103. When the hand region image in which all the pixel values are 0 is input as the hand region image (input image) in the current frame, the hand pose estimation unit 103 cannot estimate the hand pose from the hand region image, and therefore, the hand pose estimation unit 103 outputs the hand pose predicted one frame before as the future pose one frame later as the hand pose estimated in the current frame. The hand pose output from the hand pose estimation unit 103 is appropriately corrected by time smoothing processing or the like, as necessary.

### (Second Usage Example of Future Pose)

A second usage example in which the future pose is used for estimation of the hand pose in the current frame will be described. As illustrated in FIG. 10, estimation of positions of some joint points in the hand pose estimation unit 103 as information on the hand pose of the current frame may not be stable due to occlusion for the hand region image of the current frame supplied from the input image processing unit 102 to the hand pose estimation unit 103. In this case, the hand pose estimation unit 103 adopts positions of non-occlusion joint points that could be estimated, as the positions of the joint points in the current frame. On the other hand, the hand pose estimation unit 103 adopts the position of the joint point in the hand pose as the future pose one frame after predicted one frame before, as the position of the joint points in the current frame, for the position of the joint point of the occlusion for which estimation is not stable. Accordingly, the hand pose estimation unit 103 estimates the hand pose in the current frame.

The following aspects may be applied to the estimation of the hand pose in the current frame and the prediction of the future pose (hand pose) one frame later in the hand pose estimation unit 103.

The time series information of the hand pose, which is auxiliary information used by the hand pose estimation unit 103, may be data of three-dimensional coordinates of each joint point in the hand pose in the past frame. The time-series information of the hand pose, which is auxiliary information, may be data of the hand region image in the past frame. The time-series information of the hand pose, which is the auxiliary information, may be data of the feature quantity extracted at the time of estimation of the hand pose in the past frame.

Further, the time series information of the body pose, which is the auxiliary information used by the hand pose estimation unit 103, may be data of three-dimensional coordinates of each joint point in the body pose in the past frame. The time series information of the body pose, which is auxiliary information, may be data of body region image in the past frame. The time-series information of the body pose, which is auxiliary information, may be data of the feature quantity extracted at the time of estimation of the body pose in the past frame.

Further, prediction of the future pose may be performed using poses estimated in two past frames. The prediction of the future pose may be estimated using an inference model having a DNN (CNN, LSTM, or the like) structure using the pose estimated in the K past frames as an input.

According to the information processing apparatus 1 of the present embodiment described above, when the hand pose is estimated by using the auxiliary information, the hand pose can be stably estimated regardless of a recognition situation. Input information or output information regarding the estimation of the hand pose is appropriately controlled depending on the recognition situation. The current pose and the future pose are estimated simultaneously, and output information is dynamically selected depending on the recognition situation. Utilization of the prediction information makes it possible to cope with a case where image information of the current frame is not appropriate or a case where it is difficult to recognize the target (hand) due to occlusion, or the like. That is, it is possible to appropriately cope with a case where each part is hidden due to occlusion (self-occlusion or object occlusion), a case where a target texture is crushed due to a lighting situation, a case where a target pose is unclear due to blur when a movement is quick, a case where a target is far away and the sense of resolution is low, a case where a recognition angle of view is limited due to constraints on a camera structure (recognition outside the angle of view is not possible), and the like. Therefore, it is possible to obtain stable hand pose recognition accuracy even in actual cases. Further, it is possible to stably recognize the hand pose even in a case where an angle of view is limited or recognition is difficult, by using prediction pose information (future pose).

### <Example of Processing Procedure of Input Image Processing Unit 42 and Image Recognition Processing Unit 43>

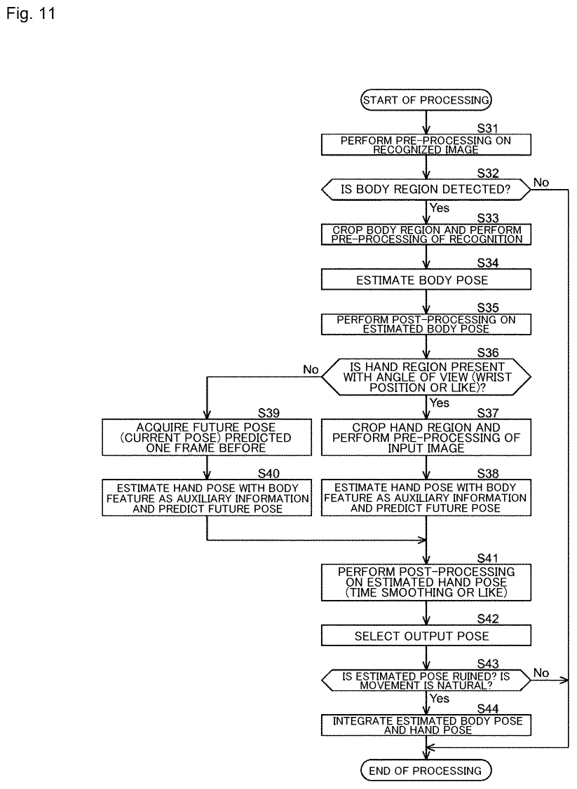

FIG. 11 is a flowchart showing an example of a processing procedure of the input image processing unit 42 and the image recognition processing unit 43 of FIG. 2. The flowchart in FIG. 11 shows a first usage example in which the future pose is used for estimation of the hand pose in the current frame. Further, the processing in the flowchart in FIG. 11 is repeatedly executed each time one frame of image is supplied from the image and depth information acquisition unit 41 to the input image processing unit 42, but description will be given assuming that processing of the flowchart in FIG. 11 ends each time processing for the image for one frame ends.

In step S31, the input image processing unit 42 performs pre-processing such as ISP or image creation processing on the image (recognized image) from the image and depth information acquisition unit 41. The processing proceeds from step S31 to step S32. In step S32, the body position detection unit 81 of the body pose estimation processing unit 61 in the image recognition processing unit 43 detects the position (image region) of the person as the body region, for the image (target image) for which the pre-processing has been performed in step S31. When the body region is not detected in step S32, the processing of this flowchart ends. When the body region is detected in step S32, the processing proceeds from step S32 to step S33.

In step S33, the input image processing unit 82 of the body pose estimation processing unit 61 in the image recognition processing unit 43 extracts (cuts out) a body region image from the target image on the basis of the body region detected in step S32, and performs pre-processing such as normalization processing on the extracted body region image. The processing proceeds from step S33 to step S34. In step S34, the body pose estimation unit 83 of the body pose estimation processing unit 61 in the image recognition processing unit 43 estimates the body pose in the current frame on the basis of the body region image subjected to the pre-processing in step S33. The processing proceeds from step S34 to step S35. In step S35, the body pose estimation unit 83 performs post-processing on the body pose in the current frame estimated in step S34. The post-processing includes corrections such as the time smoothing processing for the estimated body pose. The processing proceeds from step S35 to step S36.

In step S36, the hand position detection unit 101 of the hand pose estimation processing unit 62 in the image recognition processing unit 43 detects a position of the hand (image region) in the body region image (or target image) as the hand region on the basis of the body pose in the current frame estimated and subjected to post-processing in steps S34 and S35. When the hand region is detected in step S36, the processing proceeds from step S36 to step S37. When the hand region is not detected in step S36, the processing proceeds from step S36 to step S39.

In step S37, the input image processing unit 102 of the hand pose estimation processing unit 62 in the image recognition processing unit 43 extracts (cuts out) the hand region image from the body region image (or target image) on the basis of the hand region detected in step S36, and performs pre-processing such as normalization processing on the extracted hand region image. The processing proceeds from step S37 to step S38. In step S38, the hand pose estimation unit 103 of the hand pose estimation processing unit 62 in the image recognition processing unit 43 estimates the hand pose in the current frame on the basis of the hand region image subjected to the pre-processing in step S37 using a feature such as the body pose as the auxiliary information, and predicts the hand pose one frame later as the future pose. Since the auxiliary information is as described above, description thereof will be omitted. The processing proceeds from step S38 to step S41.

On the other hand, when the hand region is not detected in step S36, the hand pose estimation unit 103 acquires the future pose (hand pose) one frame after (current frame) predicted one frame before in step S39. The processing proceeds from step S39 to step S40. In step S40, the hand pose estimation unit 103 estimates the hand pose in the current frame on the basis of the future pose (hand pose) acquired in step S39 using the feature such as the body pose as the auxiliary information, and predicts the hand pose one frame later as the future pose. Since the auxiliary information is as described above, description thereof will be omitted. The processing proceeds from step S40 to step S41.

In step S41, the hand pose estimation unit 103 performs post-processing on the hand pose in the current frame estimated in step S38 or step S40. The post-processing includes corrections such as the time smoothing processing for the estimated hand pose. The processing proceeds from step S41 to step S42. In step S42, the hand pose estimation unit 103 selects an output pose. In the selection of the output pose, any one between the hand pose estimated in step S38 and the hand pose estimated in step S40 is output from the hand pose estimation unit 103 as the hand pose in the current frame. That is, the hand pose estimation unit 103 selects the hand pose estimated in step S38 as an output from the hand pose estimation unit 103 when the hand region is detected in step S36, and selects the hand pose estimated in step S40 as an output from the hand pose estimation unit 103 when the hand region is not detected in step S36. The processing proceeds from step S42 to step S43.

In step S43, the body and hand pose integration unit 63 in the image recognition processing unit 43 determines whether the body pose in the current frame estimated in step S34 and the hand pose in the current frame output from the hand pose estimation unit 103 in step S42 is ruined and whether the body pose and the hand pose are natural. For example, the body and hand pose integration unit 63 uses the inference model having a structure of a DNN generated by machine learning technology to determine whether the estimated body pose and hand pose are ruined, whether there are any abnormal values in the positions of the joint points, or whether the pose (movement) is natural. The inference model uses large-scale CG data or labeled data as training data to pre-learn all kinds of natural movements. Furthermore, the following method may also be adopted to determine the failure of a pose or the naturalness of movement. The estimated hand pose is input to the inference model for a determination as to whether a target is a hand or something other than the hand, and when a determination is made that the target is the something other than the hand, a determination is made that the hand pose is ruined or the movement is unnatural. The input may be the hand pose in the current frame, or may be time-series sequence information of the movement combined with the hand pose in the past frame. Further, a variational autoencoder (VAE) or the like may be used as the inference model, and the ruining of the pose or the naturalness of the movement may be determined on the basis of a degree of deviation of a pre-learned feature quantity from a potential space. In step S43, when a determination is made that the pose is ruined, or when a determination is made that the pose or movement is not natural, the processing of this flowchart ends. In step S43, when a determination is made that the pose is not ruined, and when a determination is made that the pose or movement is natural, the processing proceeds from step S43 to step S44.

In step S44, the body and hand pose integration unit 63 integrates the body pose in the current frame estimated in step S34 and the hand pose in the current frame output from the hand pose estimation unit 103 in step S42. When the processing of step S44 ends, the processing of the present flowchart ends.

### Modification Example of Auxiliary Information

The auxiliary information used at the time of estimating the hand pose is not limited to the body pose or hand pose in the past frame. For example, information that can restrict a degree of freedom of hand pose may be used as auxiliary information, as described below.

Content spoken by the user and environmental sound

Action (actions such as playing baseball, throwing a ball, cooking, kneading ingredients, and using sign language, for example)

Since a hand holding way is limited to some extent by an object held in the hand (information on a type of object and a shape of the object), the degree of freedom of the hand pose to be estimated can be reduced and stabilization of recognition or consistency of the hand pose can be improved. For example, when an object in hand is a stick, a smartphone, a steering wheel of a car, or chopsticks, information on the type or shape of the object can be used as the auxiliary information.

The auxiliary information can be converted into a feature quantity and used as the auxiliary information in estimation of the hand pose. The feature quantity may be a vector in which structural information (such as vertex coordinates) of the object is arranged, or the object in hand, for example, may be converted into a feature vector using a DNN (inference model) such as Word2Vec.

Further, the present technology can be mounted on AR glasses, a head-mounted display (HMD), a face-to-face camera for games, an in-vehicle system (user monitoring), a motion analysis device (a factory worker, an athlete, or the like), a sign language recognition device, a touchless sensing, or the like. Further, the present technology is not limited to the estimation of the hand pose, but can be applied to estimation of a pose of any object and any part.

### First Modification Example for Controlling Calculation Load

In the hand pose estimation processing, real-time stable processing is desired, but a calculation load in the information processing apparatus 1 changes dynamically depending on applications, data communication, a temperature of the information processing apparatus 1 itself, or the like.

Therefore, the calculation load in the information processing apparatus 1 may be estimated and dynamically controlled.

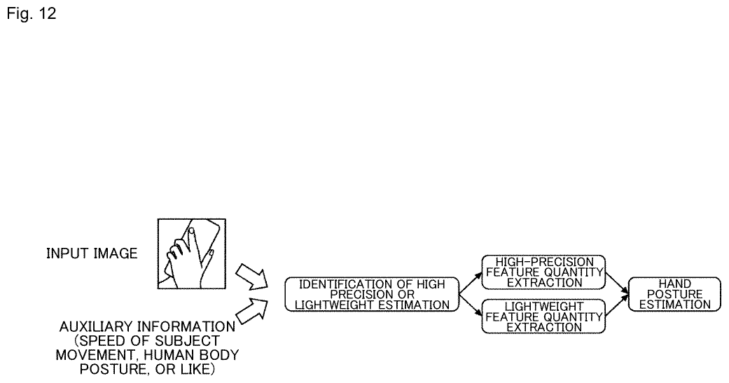

That is, the calculation load may be dynamically controlled by switching between the hand pose estimation processing based on high-precision feature quantity extraction in which the same feature quantity as in normal processing is extracted and the hand pose estimation processing based on lightweight feature quantity extraction in which the feature quantity used in the past frame is reused, on the basis of a calculation load to be estimated, as illustrated in FIG. 12. Further, for the lightweight feature quantity extraction, the feature quantities used in the past frame may be reused, and then the types or number of feature quantities to be reused may be reduced.

Accordingly, when the calculation load is estimated to be small, calculation processing based on the feature quantity extracted through the lightweight feature quantity extraction is used, and therefore, processing of extracting new feature quantity from the current frame can be omitted and the calculation load can be reduced. As a result, it is possible to reduce the calculation load as a whole, and to reduce the calculation load while maintaining the accuracy of hand pose estimation, and therefore, it is possible to realize real-time stable processing for estimating the hand pose.

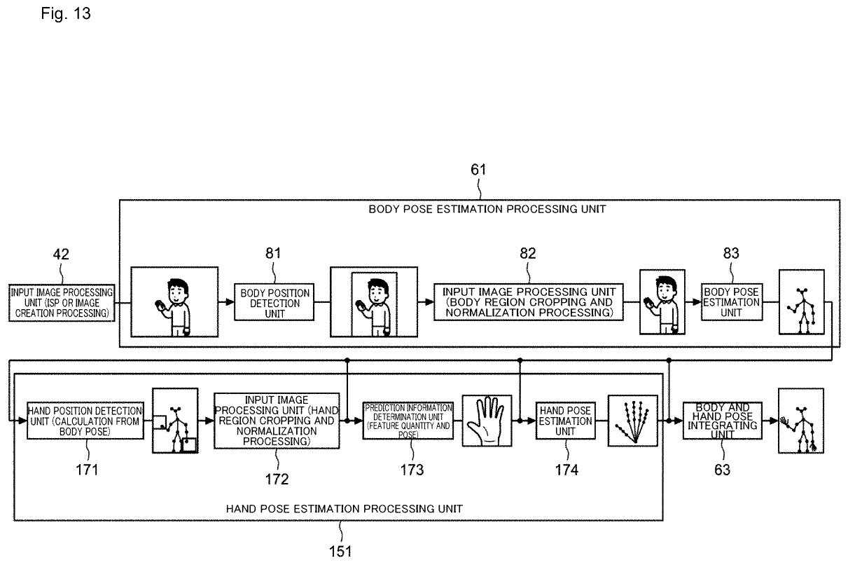

FIG. 13 is a block diagram illustrating a specific configuration example of a first modification example of the image recognition processing unit 43 of the information processing apparatus 1, in which the calculation load is dynamically controlled. In a configuration of the image recognition processing unit 43 in FIG. 13, components having the same functions as the image recognition processing unit 43 in FIG. 4 are denoted by the same reference signs, and description thereof will be omitted appropriately.

The image recognition processing unit 43 in FIG. 13 is different from the image recognition processing unit 43 in FIG. 4 in that the hand pose estimation processing unit 151 is provided in place of the hand pose estimation processing unit 62.

The hand pose estimation processing unit 151 has the same basic function as the hand pose estimation processing unit 62, but is different from the hand pose estimation processing unit 62 in that the hand pose estimation processing unit 151 has a function of dynamically controlling the calculation load.

More specifically, the hand pose estimation processing unit 151 includes a hand position detection unit 171, an input image processing unit 172, a prediction information determination unit 173, and a hand pose estimation unit 174.

Since the hand position detection unit 171 and the input image processing unit 172 have the same functions as the hand position detection unit 101 and the input image processing unit 102, respectively, description thereof will be omitted.

The prediction information determination unit 173 estimates the calculation load on the basis of the input image and the auxiliary information including the body pose and the hand pose estimated in the past frame, supplied from the body pose estimation processing unit 61, determines whether the lightweight feature quantity extraction or the high-precision feature quantity extraction is set, and outputs the information on the hand region supplied from the input image processing unit 172 to the hand pose estimation unit 174 together with the determination result.

More specifically, the prediction information determination unit 173 may determine whether the lightweight feature quantity extraction or the high-precision feature quantity extraction is set on the basis of the information on the hand region, for example, depending on a speed of movement of the hand that is the subject of the input image. In this case, when the hand that is a subject is not moving much and the speed is lower than a predetermined speed, it can be estimated that the calculation load will be small, and therefore, the lightweight feature quantity extraction is performed. On the other hand, when the hand that is a subject is moving quickly and the speed is higher than the predetermined speed, it is estimated that a calculation load equal to or larger than a predetermined amount is required to maintain the estimation accuracy, resulting in the high-precision feature quantity extraction.

Further, the prediction information determination unit 173 determines whether the lightweight feature quantity extraction or the high-precision feature quantity extraction is set, depending on a temperature of a main body of the information processing apparatus 1 or a processing frame rate of the application unit 44, for example. In this case, when the temperature of the main body of the information processing apparatus 1 is higher than a predetermined temperature or an overall processing frame rate is lower than a predetermined frame rate, it is estimated that a current calculation load places an excessive burden on the hardware. Therefore, when the current calculation load is maintained, there is a likelihood that hardware performance is reduced, resulting in a decrease in estimation accuracy. Therefore, in such a case, the lightweight feature quantity extraction is used to reduce the burden on the hardware. Since the calculation load is reduced through use of the lightweight feature quantity extraction in this manner, it is possible to reduce the temperature of the main body of the information processing apparatus 1 or to curb a decrease in the processing frame rate of the application unit 44. On the other hand, when the temperature of the main body is not higher than the predetermined temperature and the overall processing frame rate is not lower than the predetermined frame rate, the hardware is in a state where the hardware can demonstrate sufficient performance, and therefore, the high-precision feature quantity extraction is set. That is, as in this example, the auxiliary information may include information on the temperature of the main body of the information processing apparatus 1 or the processing frame rate of the application unit 44.

Further, the prediction information determination unit 173 may determine whether the lightweight feature quantity extraction or the high precision feature quantity extraction is set, for example, depending on a degree of occlusion (occlusion rate) of the hand that is the subject of the input image. In this case, for example, when the degree of occlusion (occlusion rate) is higher than a predetermined value, it is estimated that the calculation load will be high to maintain the estimation accuracy, and therefore, the high precision feature quantity extraction is set. On the other hand, when the degree of occlusion (occlusion rate) is lower than the predetermined value, it is estimated that the calculation load is small and the estimation accuracy can be maintained sufficiently, and therefore, the lightweight feature quantity extraction is set.

Further, the prediction information determination unit 173 may determine whether the lightweight feature quantity extraction or the high precision feature quantity extraction is set, for example, depending on the reliability of human body pose information. In this case, for example, when the reliability of the human body pose estimation is lower than the predetermined value, it is estimated that a calculation load equal to or larger than the predetermined amount is required to maintain the estimation accuracy, and therefore, the high-precision feature quantity extraction is used. On the other hand, when the reliability of the human body pose estimation is higher than a predetermined value, it is estimated that the calculation load is small and the estimation accuracy can be maintained sufficiently, and therefore, the lightweight feature quantity extraction is used. That is, as in this example, the auxiliary information may include the reliability of the human body pose information.

Further, the prediction information determination unit 173 may determine whether the lightweight feature quantity extraction or the high precision feature quantity extraction is set, for example, depending on the distance to the hand that is a subject. In this case, for example, when the distance to the hand that is a subject is larger than a predetermined distance, input resolution is low and a task becomes be difficult, and therefore, this is estimated that the calculation load equal to or larger than the predetermined amount is required to maintain the estimation accuracy, the high precision feature quantity extraction is used. On the other hand, when the distance to the subject is shorter than the predetermined distance, it is estimated that the calculation load is small and predetermined estimation accuracy is maintained, and therefore, the lightweight feature quantity extraction is used. To realize this example, the input image may be a depth image, or information on the distance to the subject may be acquired as the auxiliary information.

The hand pose estimation unit 174 has the basic function as the hand pose estimation unit 103, but estimates the hand pose in the current frame on the basis of the information on the hand region supplied from the input image processing unit 172, together with a determination result indicating whether the lightweight feature quantity extraction or the high precision feature quantity extraction is set, which is supplied from the prediction information determination unit 173, and predicts the hand pose one frame later (after one frame) as the future pose.

In this case, when the high-precision feature quantity extraction is set, the hand pose estimation unit 174 estimates the hand pose in the current frame on the basis of a feature quantity of the hand region image in the current frame, a feature quantity of a past body pose, and a feature quantity of the hand pose output in the past, and predicts the hand pose one frame later (after one frame) as the future pose.

Further, when the lightweight feature quantity extraction is set, the hand pose estimation unit 174 estimates the hand pose in the current frame on the basis of the feature quantity of the past body pose and the feature quantity of the hand pose output in the past, and predicts the hand pose one frame later (after one frame) as the future pose. When the lightweight feature quantity extraction is set, the types or number of feature quantities to be used may be further reduced.

### <Example of Processing Procedure of Input Image Processing Unit 42 in FIG. 2 and Image Recognition Processing Unit 43 in FIG. 13>

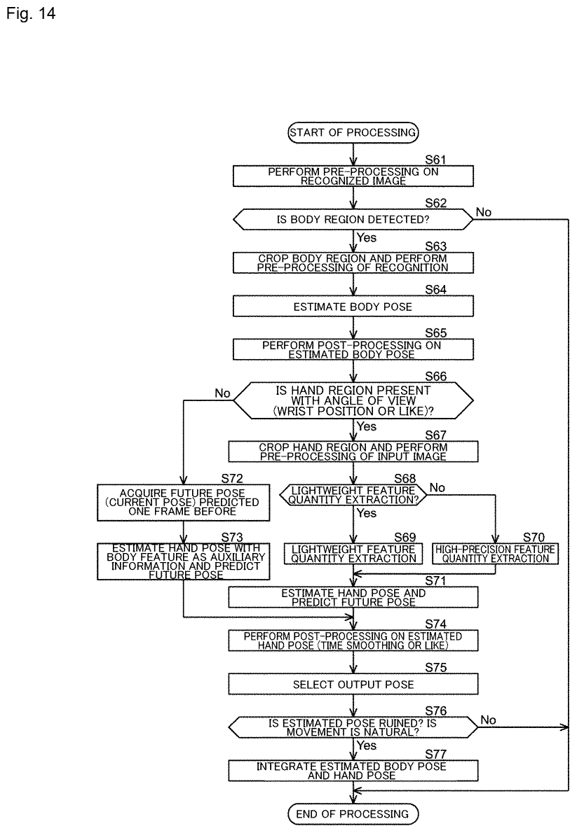

FIG. 14 is a flowchart showing an example of the processing procedure of the input image processing unit 42 of FIG. 2 and the image recognition processing unit 43 of FIG. 13. Since the processing in steps S61 to S67 and S72 to S77 in the flowchart in FIG. 14 is the same as the processing in steps S31 to S37 and S39 to S44 in the flowchart in FIG. 11, description thereof will be omitted.

In steps S61 to S67, the hand region image subjected to pre-processing such as normalization processing is generated on the basis of the image (recognized image) from the image and depth information acquisition unit 41.

The processing proceeds from step S67 to step S68. In step S68, the prediction information determination unit 173 of the hand pose estimation processing unit 151 in the image recognition processing unit 43 estimates the calculation load for the calculation related to the hand pose estimation on the basis of the body pose estimated in the input image and the past frame, the hand pose, and the auxiliary information (including information on the temperature of the main body or the processing frame rate of the application unit 44, the reliability of the human body pose information, the distance to the subject, or the like), which are supplied from the body pose estimation processing unit 61, determines whether the lightweight feature quantity extraction or the high precision feature quantity extraction is set, and outputs the hand region image supplied from the hand position detection unit 171 to the input image processing unit 172 along with a result of the determination

In step S68, for example, when the speed of movement of the hand that is the subject of the input image is lower than the predetermined speed, when the temperature of the main body is higher than the predetermined temperature or the overall processing frame rate is lower than the predetermined frame rate, when a degree of occlusion (occlusion rate) is lower than a predetermined value, when the reliability of body pose estimation is higher than a predetermined value, or when the distance to the subject is shorter than the predetermined distance, the processing proceeds from step S68 to step S69.

In step S69, the prediction information determination unit 173 estimates that the calculation load related to the hand pose estimation is smaller than the predetermined load and maintenance of the hand pose estimation accuracy is possible, determines that the feature quantity in the calculation related to the hand pose estimation is extracted by the lightweight feature quantity extraction, and outputs the information on the hand region supplied by the input image processing unit 172 to the hand pose estimation unit 174 along with a result of the determination.

On the other hand, in step S68, for example, when the speed of movement of the hand that is the subject of the input image is higher than the predetermined speed on the basis of the information on the hand region, when the temperature of the main body is lower than the predetermined temperature and the overall processing frame rate is not lower than the predetermined frame rate, when the degree of occlusion (occlusion rate) s higher than the predetermined value, when the reliability of body pose estimation is lower than the predetermined value, or when the distance to the subject is longer than the predetermined distance, the processing proceeds from step S68 to step S70.

In step S70, the prediction information determination unit 173 estimates that the calculation load involved in the hand pose estimation will be high in order to maintain the estimation accuracy, determines that the feature quantity in the calculation related to the hand pose estimation is based on the high-precision feature quantity extraction, and outputs the information on the hand region supplied from the input image processing unit 172 to the hand pose estimation unit 174 together with the determination result.

In step S71, the hand pose estimation unit 174 estimates the hand pose in the current frame through calculation depending on the determination result indicating whether the lightweight feature quantity extraction or the high-precision feature quantity extraction is set, which is supplied from the prediction information determination unit 173, and predicts the hand pose one frame later (after one frame) as the future pose.

Through the above processing, it becomes possible to realize real-time stable hand pose estimation by controlling the calculation load as to whether calculation based on the high-precision feature quantity extraction or calculation based on the lightweight feature quantity extraction is used, depending on the calculation load of the calculation related to the hand pose estimation in which the body pose and the hand pose estimated in the input image and the past frames are estimated on the basis of the auxiliary information.

### Second Modification Example for Controlling Calculation Load

An example in which the calculation load is estimated on the basis of the input image or auxiliary information, and the calculation load is dynamically controlled on the basis of the estimation result has been described. However, since the hand pose in the current frame is estimated and the future pose of the hand pose one frame later (after one frame) is predicted, the calculation load one frame later is estimated from the predicted future pose, but a determination may be made as to whether the calculation based on the high-precision feature quantity extraction or the calculation based on the lightweight feature quantity extraction, and the hand pose may be estimated on the basis of a result of the determination after one frame.

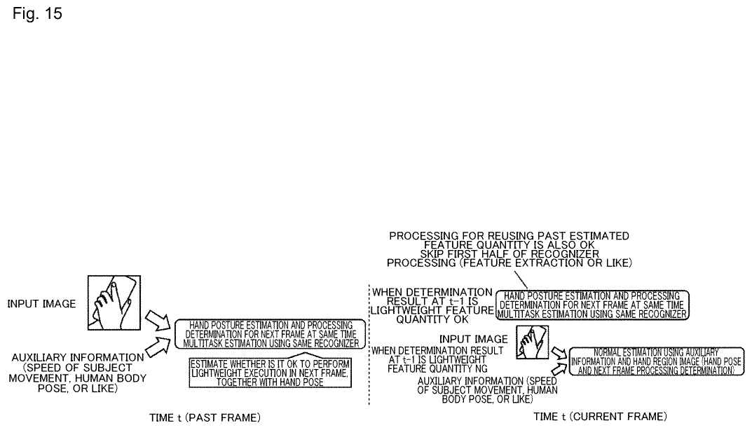

That is, as shown in a left part of FIG. 15, when the hand pose is estimated on the basis of the input image or the auxiliary information at time t−1 when a frame is a past frame, the calculation load in the next frame (a frame at time t) is estimated from the future pose of the hand pose that is predicted at the same time, a determination is made as to whether calculation based on normal feature quantity extraction (corresponding to the high-precision feature quantity extraction described above) or calculation based on the lightweight feature quantity extraction is set, and a result of the determination is carried over at time t as the determination result at time t−1.

The determination result at time t−1 one frame before is referred to at time t as shown in the right part of FIG. 15, and when the lightweight feature quantity extraction is set (lightweight feature quantity OK), the hand pose estimation is performed with a calculation load obtained by the lightweight feature quantity extraction using the past estimated feature quantity.

On the other hand, the determination result at time t−1 one frame before is referred to at time t, and when the lightweight feature quantity extraction (lightweight feature quantity NG) is not set, hand pose estimation is performed with the calculation load from the normal feature quantity extraction (the high-precision feature quantity extraction).

Thus, the calculation load in the next frame (the frame at time t) is estimated from the future pose of the hand pose that is predicted, and the calculation load may be dynamically controlled by switching between processing for extracting the same feature quantity as normal processing (the high-precision feature quantity extraction processing) and the lightweight feature quantity extraction in which the feature quantity used in past frames is reused.

Through the above processing, since a determination is made as to whether or not the lightweight feature quantity extraction is set in an immediately previous frame, it is possible to reduce the calculation load because it is not necessary to extract the feature quantity of the hand region after the hand region is cropped from the input image of the current frame and normalization processing is performed.

Even in such processing, it is possible to reduce the overall calculation load and to reduce the calculation load while maintaining the estimation accuracy, making it possible to realize real-time stable estimation processing.

In the second modification example, for example, when the hand region in the future pose of the hand pose to be predicted is not present within the angle of view, the feature quantity used in the past is used, and therefore, the lightweight feature quantity extraction is set.

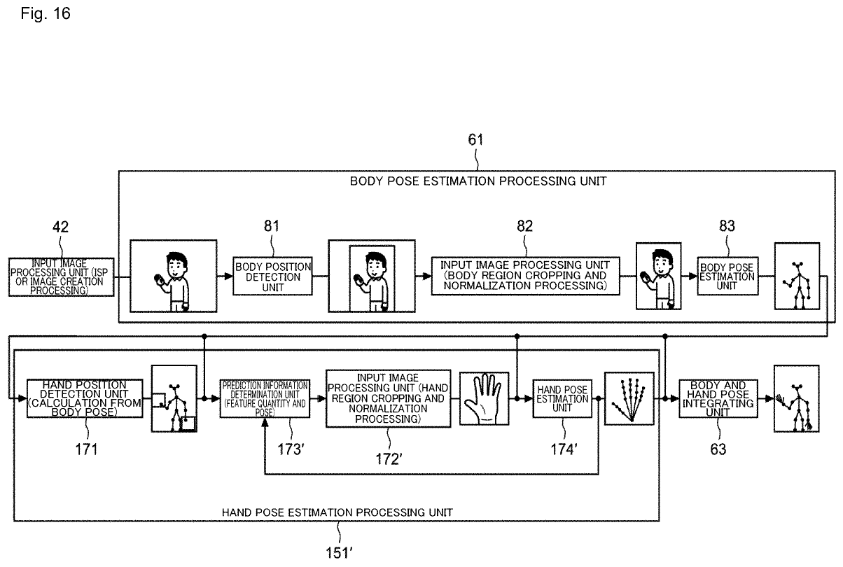

FIG. 16 is a block diagram illustrating a specific configuration example of a second modification example of the image recognition processing unit 43 of the information processing apparatus 1, in which the calculation load is dynamically controlled. In a configuration of the image recognition processing unit 43 in FIG. 16, components having the same functions as the image recognition processing unit 43 in FIG. 13 are denoted by the same reference signs, and description thereof will be omitted appropriately.

The image recognition processing unit 43 in FIG. 16 is different from the image recognition processing unit 43 in FIG. 13 in that a hand pose estimation processing unit 151′ is provided in place of the hand pose estimation processing unit 151.

The hand pose estimation processing unit 151′ has the same basic function as the hand pose estimation processing unit 151, but is different from the hand pose estimation processing unit 151 in that the calculation load in the next frame (the frame at time t) is estimated from the future pose of the hand pose that is predicted, and the calculation load may be dynamically controlled by switching between processing for extracting the same feature quantity as normal processing (the high-precision feature quantity extraction processing) and the lightweight feature quantity extraction in which the feature quantity used in past frames is reused.

More specifically, the hand pose estimation processing unit 151′ includes a hand position detection unit 171, an input image processing unit 172′, a prediction information determination unit 173′, and a hand pose estimation unit 174′.

The input image processing unit 172′, the prediction information determination unit 173′, and the hand pose estimation unit 174′ have basically the same functions as the input image processing unit 172, the prediction information determination unit 173, and the hand pose estimation unit 174, the input image processing unit 172′ and the prediction information determination unit 173′ are disposed in a reversed order. Further, the hand pose estimation unit 174′ estimates the calculation load in the next frame (the frame at time t) from the future pose of the hand pose that is predicted, and determines whether processing for extracting a feature quantity (the high precision feature quantity extraction) that is the same as normal processing or the lightweight feature quantity extraction which is processing in which the feature quantity used in the past frame is reused is set.

The prediction information determination unit 173′ outputs a result of a determination as to whether the lightweight feature quantity extraction is performed, on the basis of the calculation load of the current frame estimated from the future pose of the hand pose predicted in the immediately previous frame, to the input image processing unit 172′ together with the information on the hand region supplied from the hand position detection unit.

The input image processing unit 172′ has the same basic functions as the input image processing unit 172, but in a case where the lightweight feature quantity extraction is performed, the hand pose estimation unit 174 estimates the hand pose using only the feature quantity of the past frame and therefore, an input image of the current frame is not required and the processing is not performed. That is, the input image processing unit 172′ extracts (cuts out) the hand region image from the body region image (or target image) and performs pre-processing such as normalization processing on the extracted hand region image only when the high-precision feature quantity extraction is set.

The hand pose estimation unit 174′ has the same basic function as the hand pose estimation unit 174, but determines whether the lightweight feature quantity extraction or the high precision feature quantity extraction is set on the basis of a determination result in the immediately previous frame, estimates the hand pose in the current frame on the basis of the body poses for K past frames and the hand poses for the K frames output in the past, and predicts the hand pose one frame later (after one frame) as the future pose. Further, the hand pose estimation unit 174 estimates the calculation load on the basis of the future pose, which is the predicted hand pose one frame later (after one frame), determines whether the lightweight feature quantity extraction is set, and supplies a result of the determination to the prediction information determination unit 173′.

### <Example of Processing Procedure of Input Image Processing Unit 42 in FIG. 2 and Image Recognition Processing Unit 43 in FIG. 16>

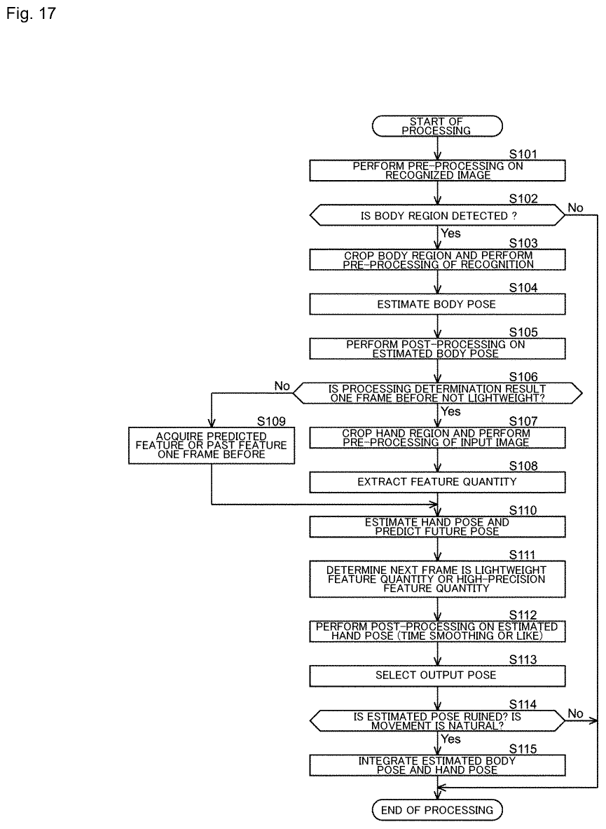

FIG. 17 is a flowchart showing an example of the processing procedure of the input image processing unit 42 of FIG. 2 and the image recognition processing unit 43 of FIG. 16. Since processing in steps S101 to S105 and S112 to S115 in the flowchart in FIG. 17 are the same as the processing in steps S31 to S35 and S41 to S44 in the flowchart in FIG. 11, description thereof will be omitted.

In steps S101 to S105, an estimated body pose subjected to pre-processing is generated on the basis of the image (recognized image) from the image and depth information acquisition unit 41.

The processing proceeds from step S105 to step S106. In step S106, the prediction information determination unit 173′ of the hand pose estimation processing unit 151′ in the image recognition processing unit 43 determines whether the lightweight feature quantity extraction is not set, depending on a calculation load in which the hand pose one frame after (current frame) predicted one frame before is estimated on the basis of the future pose from the hand pose estimation unit 174′.

In step S106, for example, when the lightweight feature quantity extraction is not set, that is, the normal feature quantity extraction (the high-precision feature quantity extraction) is set, the processing proceeds from step S106 to step S107.

In step S107, the prediction information determination unit 173′ notifies the input image processing unit 172′ that the normal feature quantity extraction is set, and supplies the information on the hand region to the input image processing unit 172′ of the hand pose estimation processing unit 151′ in the image recognition processing unit 43. The input image processing unit 172′ extracts (cuts out) the hand region image from the body region image (or target image), and performs pre-processing such as normalization processing on the extracted hand region image. The processing proceeds from step S107 to step S108.

In step S108, the hand pose estimation unit 133′ of the hand pose estimation processing unit 151′ in the image recognition processing unit 43 extracts the feature such as the body pose of the current frame as the auxiliary information. In this case, a feature quantity including the body poses for K past frames and the hand poses for K frames output in the past may also be extracted. The processing proceeds from step S108 to step S110.

On the other hand, when the lightweight feature quantity extraction is set in step S106, the prediction information determination unit 173′ notifies the input image processing unit 172′ that the lightweight feature quantity extraction is set in step S109. As a result, the input image processing unit 172′ stops its own processing and notifies the hand pose estimation unit 174′ that the current frame is for the lightweight feature quantity extraction. The hand pose estimation unit 174′ extracts only the past feature quantity including the body poses for K past frames and the hand poses for the K frames output in the past, other than the feature quantity of the current frame.

In step S110, when the hand pose estimation unit 133′ of the hand pose estimation processing unit 151′ in the image recognition processing unit 43 estimates the hand pose in the current frame on the basis of the feature quantity obtained from the hand region image subjected to the pre-processing in step S107 using the feature such as the body pose as the auxiliary information when the lightweight feature quantity extraction is not set, and predicts the hand pose one frame later as the future pose. Further, the hand pose estimation unit 133′ estimates the hand pose in the current frame on the basis of the feature of the body pose for K frames in the past and the feature of the hand poses for the K frames output in the past, other than the feature quantity of the current frame when the lightweight feature quantity extraction is set, and predicts the hand pose one frame later (after one frame) as the future pose. The processing proceeds from step S110 to step S111.

In step S111, the hand pose estimation unit 174′ estimates the calculation load on the basis of the future pose serving as the hand pose one frame later that is predicted, determines whether processing for extracting the same feature quantity as normal processing (the high precision feature quantity extraction processing) or the lightweight feature quantity extraction in which the feature quantity used in past frames is reused is set, and outputs a result of the determination to the prediction information determination unit 173′.

Through the above processing, the calculation load is estimated on the basis of the future pose serving as the hand pose one frame later that is predicted, the determination is made as to whether processing for extracting the same feature quantity as normal processing (the high-precision feature quantity extraction processing) or the lightweight feature quantity extraction in which the feature quantity used in past frames is reused is set, and a result of the determination is used in the next frame. Accordingly, since, in the lightweight feature quantity extraction, the hand pose of the current frame is estimated from the feature of the past body pose and the feature of the hand pose output in the past, processing for extracting (cutting out) the hand region image from the input image and applying, for example, pre-processing such as normalization processing to the extracted hand region image is not required, making it possible to further reduce a processing load. As a result, it becomes possible to realize real-time stable hand pose estimation.

### <Example of Combinations of Configurations>

The present technology can also have the following configuration.

(1)

An information processing apparatus comprising:
a hand pose estimation processing unit configured to estimate a hand pose in a human body on the basis of an image of the human body, the hand pose estimation processing unit estimating the hand pose using auxiliary information for limiting a degree of freedom of the hand pose.
   (2)

The information processing apparatus according to (1), wherein the hand pose estimation processing unit uses information on the hand pose estimated in the past as the auxiliary information.

(3)

The information processing apparatus according to (2), wherein the hand pose estimation processing unit predicts a future hand pose using the hand pose estimated in the past.

(4)

The information processing apparatus according to (3), wherein the hand pose estimation processing unit estimates a current hand pose using the future hand pose predicted in the past.

(5)

The information processing apparatus according to any one of (1) to (4), further comprising:

a human body pose estimation processing unit configured to estimate a human body pose of the human body on the basis of the image, wherein the hand pose estimation processing unit uses the human body pose estimated by the human body pose estimation processing unit as the auxiliary information.

(6)

The information processing apparatus according to (5), wherein the hand pose estimation processing unit uses the human body pose estimated in the past by the human body pose estimation processing unit as the auxiliary information.

(7)

The information processing apparatus according to (6), wherein the hand pose estimation processing unit predicts a future hand pose using information on the human body pose estimated in the past.

(8)

The information processing apparatus according to any one of (5) to (7), further comprising:

a pose integration unit configured to integrate a current hand pose estimated by the hand pose estimation processing unit and a current human body pose estimated by the human body pose estimation processing unit.

(9)

The information processing apparatus according to (8), wherein the pose integration unit determines whether the current hand pose and the current human body pose are ruined or natural.

(10)

The information processing apparatus according to (1), wherein the hand pose estimation processing unit further includes a determination unit configured to determine whether a calculation load related to estimation of the hand pose using the auxiliary information is reduced.

(11)

The information processing apparatus according to (10), wherein the determination unit determines whether the calculation load related to estimation of the hand pose on the basis of the auxiliary information is reduced.

(12)

The information processing apparatus according to (10), wherein the hand pose estimation processing unit predicts the future hand pose using the hand pose estimated on the basis of the auxiliary information, and the determination unit determines whether a future calculation load related to estimation of the hand pose on the basis of the predicted future hand pose is reduced.

(13)

An information processing method, including:

estimating, by a hand pose estimation processing unit of an information processing apparatus including the hand pose estimation processing unit, a hand pose in a human body on the basis of an image of the human body, and estimating the hand pose using auxiliary information that limits a degree of freedom of the hand pose.

(14)

A program for causing a computer to function as:
a hand pose estimation processing unit configured to estimate a hand pose in a human body on the basis of an image of the human body, the hand pose estimation processing unit estimating the hand pose using auxiliary information that limits a degree of freedom of the hand pose.

The present embodiment is not limited to the embodiment described above, and various changes can be made without departing from the gist of the present disclosure. Moreover, the effects described in this specification are merely examples and are not limited, and other effects may also be present.

### REFERENCE SIGNS LIST

1 Information processing apparatus
11 Camera
41 Depth information acquisition unit
42 Input image processing unit
43 Image recognition processing unit
44 Application unit
61 Body pose estimation processing unit
62 Hand pose estimation processing unit
63 Hand pose integration unit
81 Body position detection unit
82 Input image processing unit
83 Body pose estimation unit
101 Hand position detection unit
102 Input image processing unit
103 Hand pose estimation unit
151, 151′ Hand pose estimation processing unit
171 Body position detection unit
172, 172′ Input image processing unit
173, 173′ Prediction information determination unit
174, 174′ Body pose estimation unit

1. An information processing apparatus comprising:
a hand pose estimation processing unit configured to estimate a hand pose in a human body on the basis of an image of the human body, the hand pose estimation processing unit estimating the hand pose using auxiliary information for limiting a degree of freedom of the hand pose.

2. The information processing apparatus according to claim 1, wherein the hand pose estimation processing unit uses information on the hand pose estimated in the past as the auxiliary information.

3. The information processing apparatus according to claim 2, wherein the hand pose estimation processing unit predicts a future hand pose using the hand pose estimated in the past.

4. The information processing apparatus according to claim 3, wherein the hand pose estimation processing unit estimates a current hand pose using the future hand pose predicted in the past.

5. The information processing apparatus according to claim 1, further comprising:
a human body pose estimation processing unit configured to estimate a human body pose of the human body on the basis of the image, wherein
the hand pose estimation processing unit uses the human body pose estimated by the human body pose estimation processing unit as the auxiliary information.

6. The information processing apparatus according to claim 5, wherein the hand pose estimation processing unit uses the human body pose estimated in the past by the human body pose estimation processing unit as the auxiliary information.

7. The information processing apparatus according to claim 6, wherein the hand pose estimation processing unit predicts a future hand pose using information on the human body pose estimated in the past.

8. The information processing apparatus according to claim 5, further comprising:
a pose integration unit configured to integrate a current hand pose estimated by the hand pose estimation processing unit and a current human body pose estimated by the human body pose estimation processing unit.

9. The information processing apparatus according to claim 8, wherein the pose integration unit determines whether the current hand pose and the current human body pose are ruined or natural.

10. The information processing apparatus according to claim 1, wherein the hand pose estimation processing unit further includes a determination unit configured to determine whether a calculation load related to estimation of the hand pose using the auxiliary information is reduced.

11. The information processing apparatus according to claim 10, wherein the determination unit determines whether the calculation load related to estimation of the hand pose on the basis of the auxiliary information is reduced.

12. The information processing apparatus according to claim 10, wherein the hand pose estimation processing unit predicts a future hand pose using the hand pose estimated on the basis of the auxiliary information, and
the determination unit determines whether a future calculation load related to estimation of the hand pose on the basis of the predicted future hand pose is reduced.

13. An information processing method, comprising:
estimating, by a hand pose estimation processing unit of an information processing apparatus including the hand pose estimation processing unit,
a hand pose in a human body on the basis of an image of the human body, and estimating the hand pose using auxiliary information that limits a degree of freedom of the hand pose.

14. A program for causing a computer to function as:
a hand pose estimation processing unit configured to estimate a hand pose in a human body on the basis of an image of the human body, the hand pose estimation processing unit estimating the hand pose using auxiliary information that limits a degree of freedom of the hand pose.
